(19) United States
(12) Patent Application Publication
(10) Pub. No.: US 2022/0328853 A1
(43) Pub. Date: Oct. 13, 2022

(54) METHOD AND DEVICE FOR DETECTING INTERNAL CARBON DEPOSITION OF A SOLID OXIDE FUEL CELL SYSTEM

(71) Applicant: Ceres Intellectual Property Company Limited, Horsham West Sussex (GB)

(72) Inventors: Songtao Chen, Weifang, Shandong (CN); Wenmiao Chen, Weifang, Shandong (CN); Chao Yu, Weifang, Shandong (CN)

(21) Appl. No.: 17/639,524

(22) PCT Filed: Oct. 20, 2020
(86) PCT No.: PCT/IB2020/059857

§ 371 Date: Mar. 1, 2022

(30) Foreign Application Priority Data
Sep. 2, 2019 (CN) 201910822332.0

(51) Int. Cl. H01M 8/04664; H01M 8/0432; H01M 8/0438; H01M 8/04701; C01B 3/48

(52) U.S. Cl. CPC H01M 8/04679; H01M 8/04328; H01M 8/04388; H01M 8/04708; H01M 8/04738; C01B 3/48; C01B 2203/1623; C01B 2203/1619; C01B 2203/1633; C01B 2203/1652; C01B 2203/067; C01B 2203/0233; C01B 2203/0283; C01B 2203/1241

(57) ABSTRACT

A method and a device for detecting internal carbon deposition of a solid oxide fuel cell system. The method comprises the following steps: adjusting a temperature in a reformer of the solid oxide fuel cell system so that a mixed gas discharged from the reformer is at a detection temperature; sampling the mixed gas; detecting a gas sample to obtain a mole fraction of each gas, and calculating an equilibrium constant K1 of a Boudouard reaction according to the obtained mole fraction; calculating an equilibrium constant K2 of the Boudouard reaction according to thermodynamics; comparing K1 and K2, if K1 is less than K2, determining that there will be no carbon deposition in the solid oxide fuel cell system; and if K1 is greater than K2, determining that there will be carbon deposition in the solid oxide fuel cell system. By using the method, a carbon deposition condition in the solid oxide fuel cell system can be detected to effect early warning regarding the solid oxide fuel cell system and take preventive measures

### TECHNICAL FIELD

The present invention relates to the technical field of solid oxide fuel cells, particularly to a method for detecting internal carbon deposition of a solid oxide fuel cell system. The present invention further relates to a device using the method for detecting internal carbon deposition of a solid oxide fuel cell system.

### BACKGROUND ART

In a solid oxide fuel cell system, hydrogen needed for power generation of a cell stack is obtained from a reaction of methane in natural gas and water vapor in a reformer. This reaction includes a reaction of methane and water vapor and a reaction of generated carbon monoxide and water vapor, i.e., CH₄+H₂O=3H₂+CO (steam conversion reaction) and CO+H₂O=H₂+CO₂ (WGS reaction), but at the same time, side reactions will occur in the reformer, including 2 CO=C+CO₂ (Boudouard reaction) and CO+H₂=C+H₂O (carbon monoxide reduction reaction). The side reactions will cause the generation of carbon particles, resulting in carbon deposition of the internal components or pipelines of the solid oxide fuel cell system. If the carbon deposition is serious, the water vapor fed into the reformer will be suddenly interrupted, causing poisoning of the catalyst and subsequently leading to permanent

Therefore, how to detect the carbon deposition inside the solid oxide fuel cell system has become a problem.

### SUMMARY OF THE INVENTION

The present invention provides a method for detecting internal carbon deposition of a solid oxide fuel cell system, which can detect the carbon deposition condition in the solid oxide fuel cell system to effect early warning regarding the solid oxide fuel cell system and take preventive measures. The present invention further provides a device for detecting internal carbon deposition of a solid oxide fuel cell system, which is applicable to the foregoing method.

A first aspect of the invention provides a method for detecting internal carbon deposition of a solid oxide fuel cell system, wherein the method comprises the following steps:

S1, adjusting a temperature in a reformer of the solid oxide fuel cell system so that a mixed gas discharged from the reformer is at a detection temperature;
S2, sampling the mixed gas to obtain a gas sample;
S3, detecting the gas sample to obtain a mole fraction of each gas and calculating an equilibrium constant K1 of a Boudouard reaction according to the obtained mole fraction of each gas;
S4, calculating an equilibrium constant K2 of the Boudouard reaction according to thermodynamics; and
S5, comparing K1 and K2, if K1 is less than K2, determining that there will be no carbon deposition in the solid oxide fuel cell system; and if K1 is greater than K2, determining that there will be carbon deposition in the solid oxide fuel cell.

The method for detecting internal carbon deposition of a solid oxide fuel cell system can further comprise the following step:

detecting the pressure of the mixed gas after the mixed gas is at the detection temperature.

The temperature in the reformer can be adjusted multiple times to obtain a plurality of different detection temperatures, and operations from step S2 to step S5 are performed when the mixed gas is at each of the detection temperatures.

A second aspect of the invention provides a device for detecting internal carbon deposition of a solid oxide fuel cell system, applicable to the method for detecting internal carbon deposition of a solid oxide fuel cell system according to the first aspect.

The device for detecting internal carbon deposition of a solid oxide fuel cell system can comprise:

a gas outlet pipe, with one end in communication with a gas transmission pipeline between the reformer and a cell stack of the solid oxide fuel cell system, and the other end extending to the outside of a box body of the solid oxide fuel cell system to export the mixed gas discharged from the reformer to the outside of the box body;
a temperature sensor, used for detecting a temperature of the mixed gas in the gas transmission pipeline;
a sampling pipe, in communication with an end of the gas outlet pipe located outside the box body;
a pressure sensor in communication with an end of the gas outlet pipe located outside the box body;
a four-in-one detector, which can work with the sampling pipe to detect the exported mixed gas; and
a controller, which can adjust the temperature in the reformer and is in communication connection with the temperature sensor and the pressure sensor.

The pressure sensor, the sampling pipe and the end of the gas outlet pipe located outside the box body can be connected through a three-way pipe, and the set height of the pressure sensor can be greater than the set height of the sampling pipe and the set height of the end of the gas outlet pipe located outside the box body.

A manual ball valve can be arranged on the sampling pipe.

By detecting a mixed gas discharged from a reformer of a solid oxide fuel cell system, the method provided by the present invention for detecting internal carbon deposition of a solid oxide fuel cell system can detect the carbon deposition condition in the solid oxide fuel cell system to effect early warning regarding the solid oxide fuel cell system, take preventive measures, avoid damage of the solid oxide fuel cell system due to carbon deposition and better ensure the normal and safe operation of the solid oxide fuel cell system.

### BRIEF DESCRIPTION OF THE DRAWINGS

The drawings used in the description of the embodiments will be briefly described below. The drawings in the description below are just embodiments of the present invention.

FIG. 1 is a flow chart of a method for detecting internal carbon deposition of a solid oxide fuel cell system.

FIG. 2 is a structural schematic view of a device for detecting internal carbon deposition of a solid oxide fuel cell system.

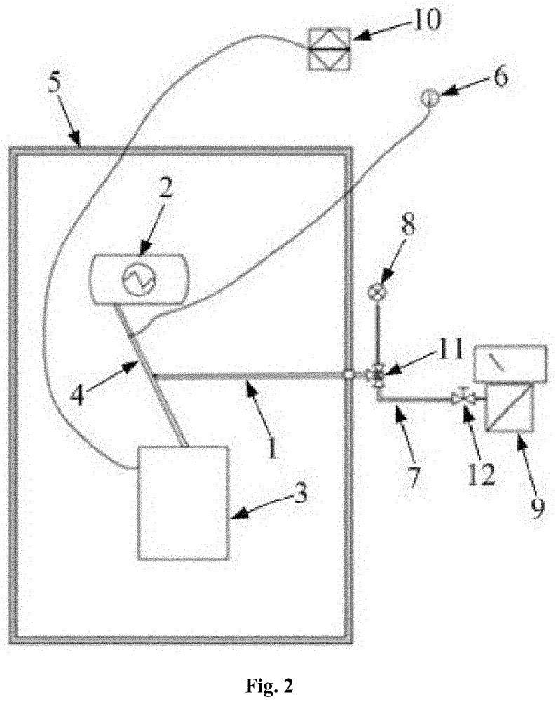

In FIG. 2, the following reference numerals are used: 1—gas outlet pipe, 2—reformer, 3—cell stack, 4—gas transmission pipeline, 5—box body, 6—temperature sensor, 7—sampling pipe, 8—pressure sensor, 9—four-in-one detector, 10—controller, 11—three-way pipe, 12—manual ball valve.

### DETAILED DESCRIPTION

The present invention provides a method for detecting internal carbon deposition of a solid oxide fuel cell system, which can detect the carbon deposition condition in the solid oxide fuel cell system to effect early warning regarding the solid oxide fuel cell system and take preventive measures.

The embodiments of the present invention will be described below in conjunction with the drawings. The described embodiments are only some, not all of the embodiments of the present invention.

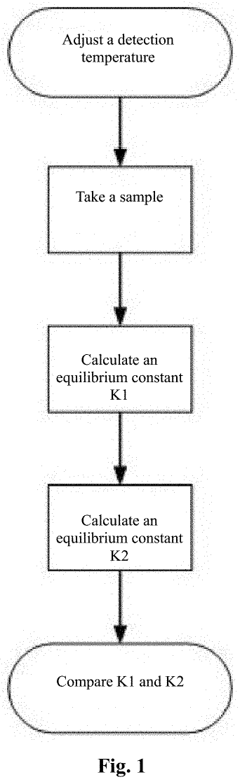

As shown in FIG. 1, an embodiment of the present invention provides a method for detecting internal carbon deposition of a solid oxide fuel cell system. Before describing the method, this embodiment first introduces the working principle and working conditions of the solid oxide fuel cell:

In the solid oxide fuel cell system, the gas needed for chemical reaction of a cell stack is hydrogen, which is mainly obtained from methane and water vapor in natural gas through catalysis in a reformer. The following four reactions describe the process of methane reforming:

CH₄+H₂O=3H₂+CO ΔH298≈206 kJ/mol (steam conversion reaction)

CO+H₂O=H₂+CO₂ ΔH298≈−41 kJ/mol (water gas shift reaction)

2CO=C+CO₂ ΔH298≈−172 kJ/mol (Boudouard reaction)

CO+H₂=C+H₂O ΔH298≈−131 kJ/mol (carbon monoxide reduction reaction)

Among the four reactions, the first two reactions are the main reactions used to generate hydrogen, sometimes collectively referred to as Sabatier reactions, and the change in the equilibrium position of each reaction is an independent reaction condition, while the latter two reactions are side effects.

Seeing from the process of the foregoing natural gas reforming reaction, the natural gas reforming process is an endothermic process. Therefore, for the continuous reforming of a solid oxide fuel cell, a heat source with sufficient heat needs to be provided to supply the heat needed for the reaction, while the side reactions during the reforming process will cause the generation of carbon particles.

According to Le Chatelier's principle, in the foregoing reaction, most of the “reactant” of methane will be consumed, so the production of H₂ will be maximized as the reaction temperature rises. When the temperature reaches 700° C., the production of H₂ will reach the maximum. However, when the reaction temperature rises, the equilibrium position changes slightly and the exothermic water gas shift reaction (this reaction is a reversible reaction) will naturally be pushed to the “left” of the chemical formula (i.e., more reactants and fewer products). Therefore, a high reforming temperature will cause more H₂ to be produced in the equilibrium of the methanation reaction, but less CO is converted through the secondary water gas shift reaction, resulting in re-reforming of the gases with a higher CO fraction at a higher temperature.

It can be seen from the foregoing Boudouard reaction that the ratio of CO to CO₂ in terms of relative concentration will affect the possible “precipitation” formed by solid carbon. One of the most critical problems in the solid oxide fuel cell system is that the fuel gas may decompose to form carbon deposition. Carbon may be generated in several places where a high-temperature fuel gas appears in the system.

In the methanation reaction, an efficient process of converting CH₄ to H₂ will appear during reforming at high temperature. If the CO:CO₂ ratio increases, care should be taken because the increase will cause the precipitation of carbon particles generated in the side reactions of reforming. Over time, it may lead to the formation of deposition in the reformer, in the pipelines or elsewhere. The accumulation of these precipitated particles will affect the flow rate of the gas used by the stack and the efficiency of hydrogen-rich reforming.

In order to ensure that the reforming process is a reasonable hydrogen-rich reforming process, the CO:CO₂ ratio should not cause the deposition of carbon particles. Under normal operating conditions, the remaining CH₄ is reformed inside the cells in the cell stack. This reforming of the cells in the cell stack will bring a beneficial cooling effect to the cell stack, making the endothermic nature of the reforming process conducive to the stack.

Based on the foregoing introduction, the method for detecting internal carbon deposition of a solid oxide fuel cell system provided by this embodiment includes the following steps:

S1, adjusting a temperature in a reformer of the solid oxide fuel cell system through a solid oxide fuel cell controller (i.e., FCU) so that a mixed gas discharged from the reformer is at a detection temperature. For example, through the FCU, the temperature in the reformer is controlled at 450° C. and when a temperature sensor (described below) on the side of the reformer detects that the mixed gas is at this temperature, subsequent operations can be performed;
S2, sampling the mixed gas to obtain a gas sample;
S3, detecting the gas sample to obtain a mole fraction of each gas, as shown in the table below for example, which is a mole fraction of each gas obtained from an actual detection; and calculating an equilibrium constant K1 of a Boudouard reaction according to the mole fraction after the mole fraction of each gas is obtained. The equilibrium constant K1 can be obtained through calculation with a calculation formula well known in the prior art. As the equilibrium constant K1 is calculated according to the actual mole fraction of each gas in the mixed gas, the equilibrium constant K1 is an actual equilibrium constant of an actual reaction and meanwhile, the equilibrium constant K1 is an actual ratio of CO:CO₂;

| | | | Detec- | | |
|---|---|---|---|---|---|
| | Sample | | tion | Result | Detection |
| Sample No. | Name | Item Name | Result | Unit | Method |
| 1921024710001 | Reform- | Hydrogen | 44.34 | % | GB/T |
| | ing gas | Methane | 43.83 | % | 13610- |
| | | Carbon | 0.90 | % | 2014 |
| | | monoxide | | | |
| | | Carbon | 9.81 | % | |
| | | dioxide | | | |

Note:
% stands for mole fraction

S4, calculating an equilibrium constant K2 of the Boudouard reaction according to thermodynamics. The thermodynamic method used to calculate the equilibrium constant K2 is also well known in the prior art. As the calculation is based on the theoretical data of each gas, the equilibrium constant K2 is a theoretical equilibrium constant. Similarly, the equilibrium constant K2 is a theoretical ratio of CO:CO₂;
S5, comparing K1 and K2, and if K1 is less than K2, determining that there will be no carbon deposition in the solid oxide fuel cell system; and if K1 is greater than K2, determining that there will be carbon deposition in the solid oxide fuel cell system and the carbon deposition will get worse.

The method for detecting internal carbon deposition of a solid oxide fuel cell system features a simple design and low cost, can not only determine the carbon deposition condition but also determine the operating state of the cell stack by detecting the composition of the reforming gas and the internal pressure of the system and can also determine whether the temperature in the reforming process is in the range controlled by the FCU, whether the reforming process is efficient and whether the internal coating of the reformer is effective.

Preferably, the foregoing method further comprises the following step: detecting the pressure of the mixed gas after the mixed gas is at the detection temperature. As the pressure of the gas is also related to the change in the equilibrium constant, in order to further improve the detection accuracy, the embodiment preferably detects the pressure while selecting the temperature.

Further, in order to more accurately determine the carbon deposition condition, this embodiment preferably performs a plurality of detection operations and the detection temperature of each detection is different; that is, the temperature in the reformer is adjusted multiple times to obtain a plurality of different detection temperatures, and steps S2 to S5 are performed when the mixed gas is at each detection temperature.

As shown in FIG. 2, an embodiment of the present invention further provides a device for detecting internal carbon deposition of a solid oxide fuel cell system. The device is applicable to the foregoing method for detecting internal carbon deposition of a solid oxide fuel cell system.

As shown in FIG. 2, the foregoing device comprises a gas outlet pipe 1, with one end in communication with a gas transmission pipeline 4 between the reformer 2 and a cell stack 3 of the solid oxide fuel cell system, and the other end extending to the outside of a box body 5 of the solid oxide fuel cell system to export the mixed gas discharged from the reformer 2 to the outside of the box body 5. A temperature sensor 6, which is preferably a thermocouple, can be arranged outside the box body 5 and is used for detecting a temperature of the mixed gas in the gas transmission pipeline 4, which is also a reforming temperature in the reformer 2. A sampling pipe 7, in communication with an end of the gas outlet pipe 1 is located outside the box body 5. A pressure sensor 8, in communication with an end of the gas outlet pipe 1 is located outside the box body 5 and used for detecting the pressure of the mixed gas. A four-in-one detector 9, which can work with the sampling pipe 7 is provided to detect the exported mixed gas. The gases that can be detected by the four-in-one detector 9 include hydrogen, methane, CO and CO₂. A controller 10, which can adjust the temperature in the reformer 2 is in communication connection with the temperature sensor 6 and the pressure sensor 8.

The temperature of the solid oxide fuel cell system during reaction can be more than 800 degrees Celsius, and each pipeline is connected through components and special pipes. It is unrealistic to directly collect and detect a mixed gas in the reformer 2 located inside the box body 5, so in order to implement the detection smoothly, a gas outlet pipeline 1 is connected on the gas transmission pipeline 4 that is used for transmitting a mixed gas after reaction between the reformer 2 and the cell stack 3, one end of the gas outlet pipe 1 is led to the outside of the box body 5 and the controller 10 (the controller 10 preferably is an FCU; that is, the control program of the original FCU is changed to add detection-related functions on the basis of the original functions of the FCU) is used to control the temperature of the gas in the reformer 2. The temperature value can be obtained according to a temperature signal sent to the controller 10 by the temperature sensor 6. For example, in order to compare whether the gas composition in the reformer 2 at 450° C. is consistent with the theoretical calculation result, the FCU can be used to control the temperature of the reformer 2 at 450° C. When the value displayed on the controller 10 is this temperature value according to the detection of the temperature sensor 6, a mixed gas can be collected through the sampling pipe 7. The specific collection process is as follows: the mixed gas enters the sampling pipe 7 after flowing through the gas outlet pipe 1, and after the mixed gas is cooled in the sampling pipe 7, the mixed gas eventually enters a sampling bottle of the four-in-one detector 9; meanwhile, the pressure sensor 8 detects the pressure of the mixed gas exported from the gas outlet pipe 1 and sends a pressure signal obtained from the detection to the controller 10.

In the foregoing structure, a length of the gas outlet pipe 1 staying outside the box body 5 can be calculated according to the actual maximum working temperature of the cell stack 3 and a thermodynamic formula.

The pressure sensor 8, the sampling pipe 7 and an end of the gas outlet pipe 1 located outside the box body 5 are connected through a three-way pipe 11, and preferably, the set height of the pressure sensor 8 is greater than the set height of the sampling pipe 7 and the set height of the end of the gas outlet pipe 1 located outside the box body 5, as shown in FIG. 2. The three-way pipe 11 is used so that its first port extends upward and is in communication with the pressure sensor 8, its second port extends horizontally and is in communication with the end of the gas outlet pipe 1 located outside the box body 5, and its third port extends horizontally or downward and is in communication with the sampling pipe 7. The set height of the pressure sensor 8 preferably is greater than the other two in order to more accurately measure the pressure of the mixed gas. If the set height of the pressure sensor 8 is lower than the height of the sampling pipe 7, the steam in the mixed gas will be turned into water due to condensation and the height of the water column will affect the measuring accuracy of the pressure sensor 8. Therefore, in order to avoid this problem, preferably the set height of the pressure sensor 8 is greater than the other two.

As shown in FIG. 2, in the embodiment, it is preferred that a manual ball valve 12 is arranged on the sampling pipe 7. This manual valve helps operators to more conveniently control the gas collection process.

The structure of each part in the description is described in progressive manner and focuses on the differences from the existing structure. The overall and partial structure of the device for detecting internal carbon deposition of a solid oxide fuel cell system can be obtained by combining the structures of the foregoing plurality of parts.

Various modifications to these embodiments will be apparent. The general principle defined herein can be implemented in other embodiments without departing from the scope of the present invention.

1. A method for detecting internal carbon deposition of a solid oxide fuel cell system, comprising:
S1, adjusting a temperature in a reformer of the solid oxide fuel cell system so that a mixed gas discharged from the reformer is at a detection temperature;
S2, sampling the mixed gas to obtain a gas sample;
S3, detecting the gas sample to obtain a mole fraction of each gas and calculating an equilibrium constant K1 of a Boudouard reaction according to the obtained mole fraction of each gas;
S4, calculating an equilibrium constant K2 of the Boudouard reaction according to thermodynamics; and
S5, comparing K1 and K2, and if K1 is less than K2, determining that there will be no carbon deposition in the solid oxide fuel cell system; and if K1 is greater than K2, determining that there will be carbon deposition in the solid oxide fuel cell.

2. The method for detecting internal carbon deposition of a solid oxide fuel cell system according to claim 1, further comprising:
detecting the pressure of the mixed gas at the detection temperature.

3. The method for detecting internal carbon deposition of a solid oxide fuel cell system according to claim 1, wherein the temperature in the reformer is adjusted multiple times to obtain a plurality of different detection temperatures, and S2 to S5 are performed when the mixed gas is at each of the different detection temperatures.

4. A device for detecting internal carbon deposition of a solid oxide fuel cell system, wherein the device is configured to perform the method of claim 1.

5. The device for detecting internal carbon deposition of a solid oxide fuel cell system according to claim 4, comprising:
a gas outlet pipe, with one end in communication with a gas transmission pipeline between a reformer and a cell stack of the solid oxide fuel cell system, and the other end extending to the outside of a box body of the solid oxide fuel cell system to export the mixed gas discharged from the reformer to the outside of the box body;
a temperature sensor, used for detecting a temperature of the mixed gas in the gas transmission pipeline;
a sampling pipe, in communication with an end of the gas outlet pipe located outside the box body;
a pressure sensor, in communication with an end of the gas outlet pipe located outside the box body;
a four-in-one detector, which configured to work with the sampling pipe to detect the exported mixed gas; and
a controller, which is configured to adjust the temperature in the reformer and is in communication with the temperature sensor and the pressure sensor.

6. The device for detecting internal carbon deposition of a solid oxide fuel cell system according to claim 5, wherein the pressure sensor, the sampling pipe and the end of the gas outlet pipe located outside the box body are connected through a three-way pipe, and the set height of the pressure sensor is greater than the set height of the sampling pipe and the set height of the end of the gas outlet pipe located outside the box body.

7. The device for detecting internal carbon deposition of a solid oxide fuel cell system according to claim 5, wherein a manual ball valve is arranged on the sampling pipe.
